(19) United States
(12) Patent Application Publication
(10) Pub. No.: US 2007/0159758 A1
(43) Pub. Date: Jul. 12, 2007

(54) Protective circuit for thunderbolt abrupt waves

(75) Inventor: Robert Wang, Taoyuan (TW)

Correspondence Address: BRUCE H. TROXELL, SUITE 1404, 5205 LEESBURG PIKE, FALLS CHURCH, VA, 22041, US

(73) Assignee: Ceramate Technical Co., Ltd.

(21) Appl. No.: 11/327,506

(22) Filed: Jan. 9, 2006

(51) Int. Cl. H02H 9/06

(52) U.S. Cl. 361/118

(57) ABSTRACT

A protective circuit for thunderbolt abrupt waves includes an excessive current protector and an abrupt absorber. The excessive current protector is a single or plural strand metal lend, The single strand metal lead possesses a diameter in the range of 0.23 mm-0.35 mm, and the plural stand metal lead has a cross-sectional area in the range of 0.0415 mm²-0.0962 mm². So on one hand, the abrupt wave absorbers can surely serve its duty, and the other hand, the metal lead can be molten in case of abnormal current so as to protect the abrupt wave absorbers from burning up or exploding.

### BACKGROUND OF THE INVENTION

1. Field of the Invention

This invention relates to a protective circuit, particularly to one absorbing thunderbolt abrupt waves and preventing electric appliances from burning up or exploding caused by continual abnormal current.

2. Description of the Prior Art

A common protective circuit for thunderbolt waves absorbs abrupt wave s generated by thunder bolt for preventing electric appliances from burning up. Common conventional protective circuits for thunderbolt waves generally have a temperature fuse in an electric circuit, or a printed copper foil as a fuse used in a printed electric circuit so that the fuse can be immediately. burned up to cut off the electric circuit at the moment when the electric circuit receives abnormal current. For example, if a current of 50 A/240 Vac, 150 A/240 Vac or 1000 A/240 Vac happens, the fuse never fails to be burned up, so there is still a danger of burning up-or explosion of an abrupt wave absorber caused by high temperature. Therefore, almost all electric appliances have to pass rigid test of UL 1449 safety certificate, or they are not. permitted to sell legally. Provided that the fuse used in a protective circuit for thunderbolt waves is not stable in its specification and quality, it can hardly pass the UL safety certificate because of the potential danger, deemed as an unsafe product impossible to sell legally.

### SUMMARY OF THE INVENTION

The feature of the invention is a single. or plural strand metal lead used as an excessive current protector in a protective circuit for thunderbolt abrupt waves. The single strand metal lead has a diameter in the range of 0.023 mm-0.035 mm, and the plural strand metal lead has a cross-sectional area in the range of 0.041 mm²-0.0962 mm². Therefore, the abrupt wave absorbers can fully serve their duty on one hand, and the excessive current protector can be immediately molten by abnormal current, protecting the abrupt wave absorbers from burning up or exploding.

### BRIEF DESCRIPTION OF DRAWINGS

This invention will be better understood by referring to the accompanying drawings, wherein:

FIG. 1 is a diagram of a protective circuit for thunderbolt abrupt waves in the present invention;

FIG. 2 is a cross-sectional view of a single strand metal lead of a preset diameter in the present invention;

FIG. 3 is a cross-sectional view of a plural stand metal lead in the present invention;

FIG. 4 is a cross-sectional view of a metal lead of a preset area with a square shape in the present invention;

FIG. 5 is a cross-sectional view of a metal lead wrapped with a layer of glass in the present invention; and,

FIG. 6 is a cross-sectional view of a metal lead wrapped with a layer of porcelain in the present invention.

### DETAILED DESCRIPTION OF THE PREFERRED EMBODIMENT

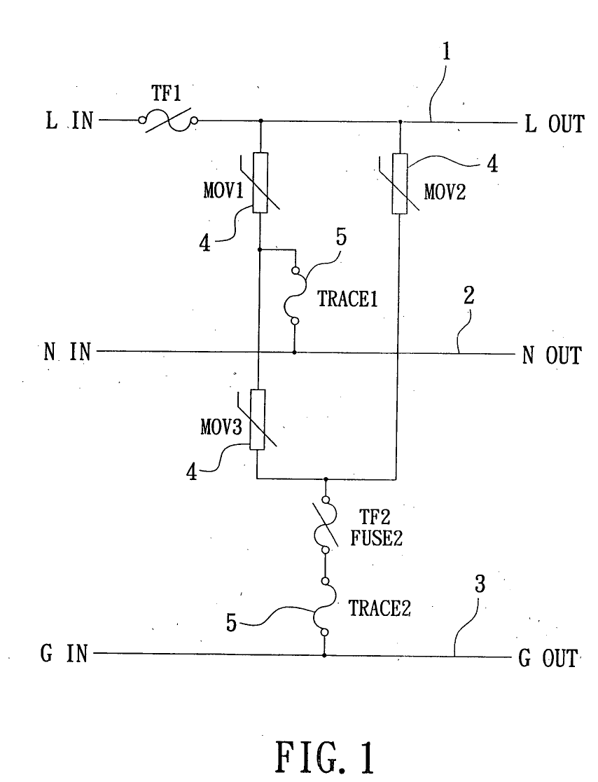

A preferred embodiment of a protective circuit for thunderbolt abrupt waves in the present invention, as shown in FIG. 1, includes a abrupt wave absorber (MOV1, MOV3, MOV2) 4 respectively connected. in parallel between a fire line (L) 1 and a center line (N) 2, between the center line (N) 2 and a grounding line (G) 3, and between the fire line (L) 1 and the grounding line (G) 3, and an excessive current protector (TRACE1, TRACE2) 5 respectively connected in series with the abrupt wave absorbers 4.

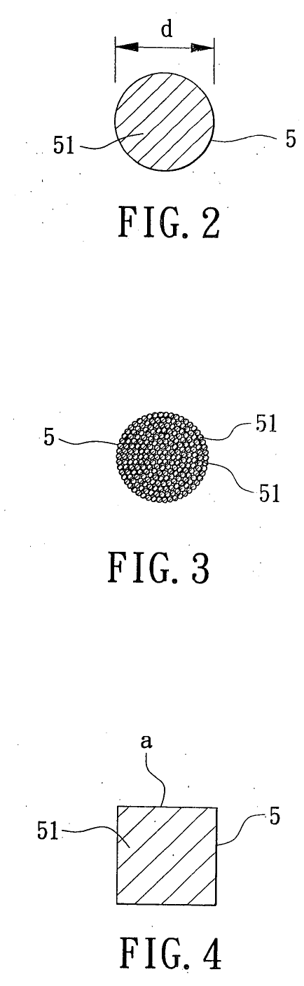

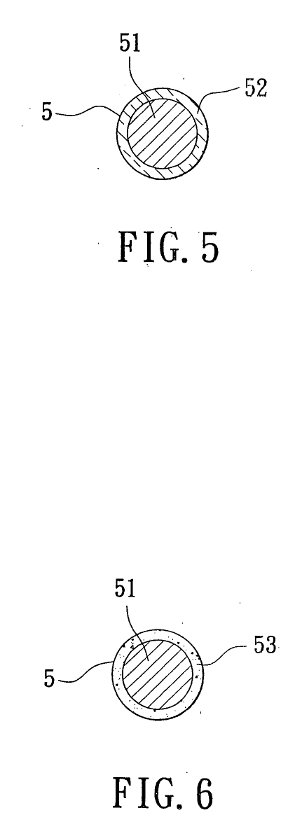

The excessive current protector 5 is a single strand metal (copper) lead 51, as shown in FIG. 2, or a plural strand metal lead shown in FIG. 3. The single strand metal lead 51 preferably has a diameter in the range of 0.23 mm-0.35 mm, and the plural strand metal lead preferably has a cross-sectional area in the range of 0.0415 mm²-0.0962 mm². Further, the single grand metal lead 51 can have an area in the range of 0.0415 mm² to 0.096 mm² with a square cross-section shown in FIG. 5.

Next, a layer of an insulating material can be added to wrap around the excessive current protector 5, and the insulating material can be a layer of glass 52 wrapped around the excessive current protector 5, as shown in FIG. 5, Or a layer of porcelain 53, plastic rubber, epoxy, etc. can be used in place of the glass, as shown in FIG. 6, for attaining function of insulation.

Now it should be particularly mentioned that the protective circuit for thunderbolt abrupt waves makes use of a single or plural stand metal lead 51 as the excessive current protector 5. As, the metal lead 51 can be made stably to have a particularly regulated diameter or an cross-sectional area, the excessive current protector 5 cannot be molten when a thunderbolt abrupt wave of 6 KV(1.2×50 μs)/3KA(8×20 μs) passes through the protective circuit so that the abrupt wave absorbers 4 can function efficiently for absorbing the abrupt wave of the thunderbolt and attaining the objective of protecting electric appliances. On the other hand, if an abnormal continual current of 50 A/240 Vac, 150 A/240 Vac or 1000 A/240 Vac passes through the protective circuit, the excessive current protector 5 can be molten by high temperature caused by thunderbolt abrupt waves so that electric appliances can be protected from burning up or exploding.

While the preferred embodiment of the invention had been described above, it will be recognized and understood that various modifications may be made therein and the appended claims are intended to cover all such. modifications that may fall within the spirit and scope of the invention.

What is claimed is:

1. A protective circuit for thunderbolt abrupt waves, said protective circuit comprising a abrupt wave absorber respectively connected in parallel between a fire line and a center line of a power source, between said center line and a grounding line, and between said fire line and said grounding line, an excessive current protector connected in series with said abrupt wave absorber; and,
said excessive current protector being a copper lead, having a diameter in the range of 0.23 mm-0.35 mm, said excessive current protector impossible to be molten in case that a thunderbolt wave of 6 KV(1.2×50 μs)/3 KA(8×20 μs) passes through said protective circuit, said excessive current protector immediately being molten in case that continual current of 50 A/240 Vac, 150 A/240 Vac or 1000 A/240 Vac passes through said excessive current protector, said abrupt wave absorber possible to be prevented from burning up or exploding caused by high temperature.

2. The protective circuit as claimed in claim 1, wherein said excessive current protector is wrapped around with a layer of glass.

3. The protective circuit as claimed in claim 1, wherein staid excessive current protector is coated and wrapped around with a layer of insulating material.

4. The protective circuit as claimed in claim 3, wherein said insulating material is porcelain.

5. The protective circuit as claimed in claim 3, wherein said insulating material is plastic rubber.

6. The protective circuit as claimed in claim 3, wherein said insulating material is epoxy.

7. A protective circuit for thunderbolt abrupt waves, said protective circuit comprising an abrupt wave absorber respectively connected in parallel between a fire line and a center line of a, power source, between said fire line and a grounding line, and between said fire line and said grounding line, an excessive current, protector connected in series respectively with said abrupt wave absorbers; and,
said excessive current protector being a plural strand copper lead, said copper lead having a cross-sectional area in the range of 0.0415 mm²-0.0962 mm² so that said excessive current protector is impossible to be molten in case that a thunderbolt wave of 6 KV(1.2×50 μs)/3 KA(8×20 μs) passes through said protective circuit, said excessive current protector possible to be immediately molten in case that continual current of 50 A/240 ac, 150 A/240 ac or 1000 A/240 ac passes through said protective circuit; said abrupt wave absorbers possible to be protected from burning up or exploding.

8. The protective circuit as claimed in claim 7, wherein said excessive current protector is wrapped around with a layer of glass.

9. The protective circuit as claimed in claim 7, wherein said excessive current protector is coated and wrapped around with a layer of insulating material.

10. The protective. Circuit as claimed in claim 9, said insulating material is porcelain.

11. The protective circuit as claimed in claim 9, wherein said insulating material is plastic rubber.

12. The protective circuit as claimed in claim 9, wherein said insulating material is epoxy.
